(19) United States
(12) Patent Application Publication
(10) Pub. No.: US 2011/0185208 A1
(43) Pub. Date: Jul. 28, 2011

(54) MEMORY POWER REDUCTION IN A SLEEP STATE

(75) Inventors: Derek Iwamoto, Sunnyvale, CA (US); Steven J. Sfarzo, Los Gatos, CA (US); Ryan Schmidt, San Jose, CA (US); Derrick Carty, Los Altos, CA (US); Keith Cox, Sunnyvale, CA (US)

(73) Assignee: APPLE INC., Cupertino, CA (US)

(21) Appl. No.: 12/895,702

(22) Filed: Sep. 30, 2010

Related U.S. Application Data
(60) Provisional application No. 61/299,295, filed on Jan. 28, 2010.

(51) Int. Cl. G06F 1/32

(52) U.S. Cl. 713/323

(57) ABSTRACT

A data processing system that uses memory power reduction in a sleep state. The system can include a volatile memory and at least one data input peripheral and a logic circuit that is configured to manage power consumption of the data processing system for a sleep of the system. The logic circuit can be coupled to the volatile memory and can be configured to turn off power to the volatile memory in response to an event, occurring during the sleep state, but to otherwise remain in the sleep state. The sleep state can be an ACPI complaint S3 sleep state in which the volatile memory, such as DRAM, is powered off after a period of user inactivity during the S3 sleep state.

### RELATED APPLICATIONS

This application claims the benefit of U.S. Provisional Application No. 61/299,295 filed on Jan. 28, 2010, which application is incorporated herein by reference.

### BACKGROUND OF THE INVENTION

The various embodiments described herein relate to power management of a data processing system. Various techniques are known in the art to reduce power consumption in a data processing system, particularly for devices or systems that are battery powered.

A sleep state is commonly used in some data processing systems to reduce power consumption. In a sleep state, the display of the device can be off (e.g. the backlight of a liquid crystal display (LCD) is off), and the hard drive or other non-volatile storage device is off (e.g. the disk or disks of the hard drive are not spinning) and the processing system, such as a microprocessor, is in a low power state which can be off, but the volatile memory of the data processing system, such as the DRAM, is fully powered. The sleep state can conserve power and, at the same time, due to the fact that the DRAM is receiving power, quickly wake up from the sleep state. The quick wake up from the sleep state is a favorable characteristic desired by users who want to be able to return to use of the data processing system after it is asleep, while at the same time being able to obtain benefit from the power reduction state provided by the sleep state. An example of such a sleep state is the S3 state in the ACPI complaint systems. ACPI (Advanced Configuration and Power Interface) is an open standard that defines power management procedures and allows operating system control of power management for the data processing system which utilizes the operating system. The ACPI standard also describes other low power consumption states, such as the S4 and the S5 states which consume less power than the S3 state. In the S4 state, also known as a hibernation state, all content of main memory (e.g. the DRAM content) is saved to a non-volatile memory device such as a hard drive and is powered down. The S5 state may be considered a shutdown state from which the user restarts the system with a boot process from a hard drive or other non-volatile memory which stores the operating system. Generally, a system may only return from an S4 state or an S5 state when receiving a signal indicating that a power button on the device has been pressed. The entire boot process can take a long time as is known in the art.

### SUMMARY OF THE DESCRIPTION

Exemplary embodiments of systems, machine readable storage medium, and methods for implementing power reduction in a sleep state are described. A system in one embodiment can include a volatile memory, such as DRAM, at least one data input peripheral and a logic circuit that is configured to manage power consumption of the data processing system for a sleep state of the system. The logic circuit can be coupled to the volatile memory and can be configured to turn off power to the volatile memory in response to an event, which occurs during the sleep state, but to otherwise remain in the sleep state which existed prior to the event. In one embodiment, the event may be the expiration of a timer or counter which was started in response to entry into the sleep state. The sleep state can be an ACPI complaint S3 sleep state prior to the event, and the volatile memory, such as DRAM, can be powered off, in response to the event, after a period of user inactivity during the S3 sleep state. The system can remain in the S3 sleep state after powering off the DRAM. Both before the event and after the event, the system can respond to an input from the data input peripheral, such as a keyboard or a touch screen or a mouse to cause the system to exit from the sleep state.

In one embodiment, the volatile memory can be a dynamic random access memory that requires refreshing to maintain data in the DRAM, and the DRAM can employ a self-refreshing approach to allow power reduction to be achieved in a memory management unit (MMU) while the system is in a sleep state. In certain embodiments, the event may also be triggered by a user input in addition to or rather than the expiration of a timer or a counter.

In one embodiment, a system can include a sleep indicator, such as an LED (Light Emitting Diode) that indicates to the user that the system is in a sleep state, such as the S3 sleep state described herein. In one implementation, the sleep indicator may blink slowly to indicate to the user that the system is in a sleep state, and in other states (e.g. S0 or S5), the sleep indicator is off and does not blink.

In one embodiment, a method may include entering a sleep state in which a volatile memory of the data processing system receives power and a processor is powered off or is otherwise in a reduced power state, and determining an event has occurred (e.g. a timer has expired) during the sleep state and, in response to the event (and in certain embodiments in response to determining other conditions), removing power from the volatile memory but otherwise remaining in the sleep state. The data processing system can be configured in this method to exit from the sleep state in response to an input from a data input peripheral such as a mouse, a keyboard, or a touch screen. In one embodiment, the method may further include causing a sleep indicator to indicate a sleep condition when the data processing system is in a sleep state. The method can further include storing data in the RAM into a non-volatile memory, such as a hard drive or solid state disk, before entering the sleep state or before powering off the DRAM.

In one embodiment, a system according to the present invention is capable of operating in at least the following ACPI compliant states: S0; S3; and S5. In one embodiment, the expiration of the timer or counter while in the S3 sleep state occurs after a period of user inactivity relative to one or more of the data input peripherals. In one implementation, the expiration of the timer can occur after a period of user inactivity relative to all of (or a selected subset of) the plurality of data input peripherals coupled to the data processing system.

### BRIEF DESCRIPTION OF THE DRAWINGS

The present invention is illustrated by way of example and not limitation in the figures of the accompanying drawings in which like references indicate similar elements.

FIG. 1 is a flow chart showing a method according to one embodiment of the present invention.

FIG. 2 is a block diagram of a system according to one embodiment of the present invention.

FIG. 3 is a block diagram showing portions of a system according to one embodiment of the present invention.

FIG. 4 is a block diagram of an alternative embodiment of a portion of a system according to one embodiment of the present invention.

FIG. 5 is a flow chart showing a method according to one embodiment of the present invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

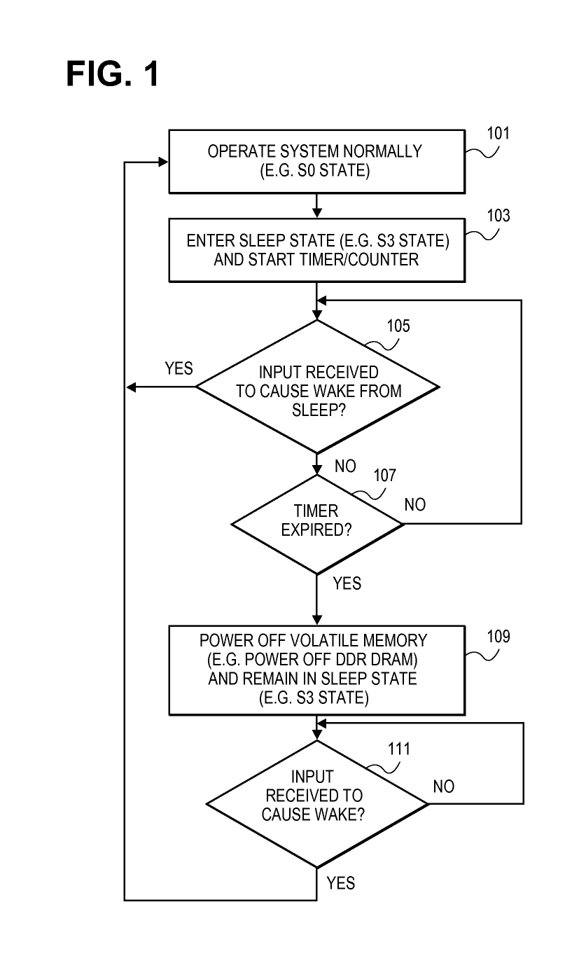

In one embodiment, a data processing system can enter a low power state, such as a sleep state, with volatile memory receiving power when in that state and then, upon the occurrence of an event, power which is supplied to the volatile memory is removed or reduced in response to the event but otherwise the system remains in the low power or sleep state. FIG. 1 shows a method according to one embodiment of the present invention. In operation 101, the system operates normally. In a typical implementation, this would include providing full power to a microprocessor, to a hard drive, to DRAM, to the data input peripherals (e.g. peripherals that supply data to a processor such as a mouse, touch screen or a keyboard), and to a display device. In one implementation, this may represent an S0 ACPI state of operation for the data processing system. Alternatively, the operating state may be an S1 or S2 ACPI state as is known in the art. An operating system can transition to a sleep state in any one of a variety of ways. For example, a user can set or a system can set a timer which causes certain power reductions to occur. The power reduction may be a transition from the S0 to an S1 or from the S0 to an S2 state or from an S0 to an S1 and then to an S2 and then to an S3 state. There may be individual timers for each of these transitions, and the system may utilize other timers, such as a display timer which dims the display after a user period of time, etc. Operation 103, shown in FIG. 1, shows that the system has transitioned to a sleep state, which may be an S3 state and, in response to the transition, the system has started a timer or counter which is used to determine, in one embodiment, whether to remove power or otherwise reduce power to a volatile memory, such as a DDR DRAM volatile memory; this timer or counter can be referred to as a DRAM timer or counter to distinguish from timers (which can be referred to as sleep timers) used to cause a transition from operation 101 (e.g. an S0 state) to a sleep state. The entry into the sleep state shown in operation 103 may occur through the expiration of a timer (which can be different than the DRAM timer) or through receiving of a user command which instructs the system to go into a sleep state. Typically, the sleep timer (which is different than the DRAM timer) can be reset by user activity, but if there is no user activity for a period of time counted by the sleep timer, then the sleep timer can expire and cause entry into the sleep state in operation 103. Optionally, the system can cause the storage of the contents of the DRAM or other volatile memory into a non-volatile storage, such as a hard drive, flash memory, etc. This saving of data from the DRAM into a non-volatile memory may be performed in operation 103 or in operation 109, at least in certain embodiments. After entering the sleep state in operation 103, the system will typically periodically perform operations 105 and 107 in order to determine whether to wake from sleep in the case of operation 105 or in order to determine, in the case of operation 107, whether to power off the volatile memory.

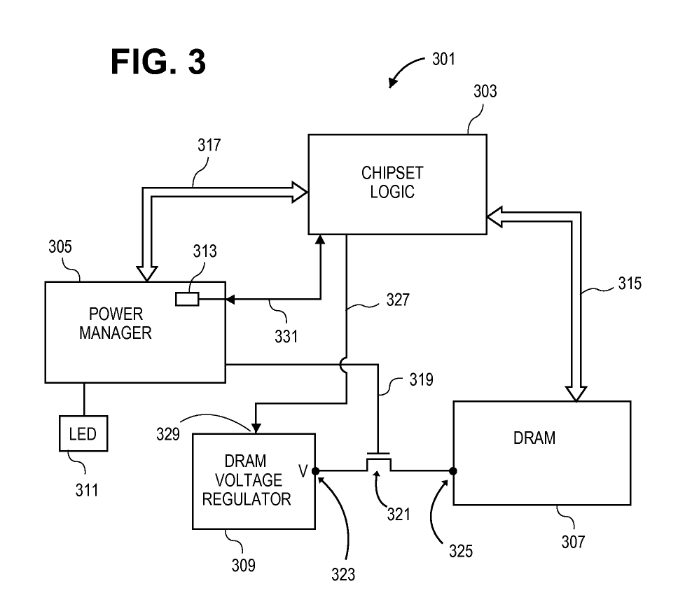

In operation 105, the system can determine whether an input has been received to cause a wake from sleep. In the sleep state, a plurality of potential wake sources (e.g., peripheral devices) remains powered and capable of providing an input to cause a wake from sleep. The input, in one embodiment, can be provided by any one of a plurality of peripherals coupled to the data processing system or in another embodiment, any one of a subset of those peripherals of the data processing system. For example, in one embodiment of a laptop computer system, an input to a keyboard or an input to a mouse can cause the system to wake from sleep while an input to an integrated touch pad or mouse on the laptop computer will not cause the system to wake from sleep. If an input is received, then operation 105 proceeds back to operation 101 as shown in FIG. 1. In certain embodiments, the return from operation 105 to operation 101 can include checking of a register, such as the register 313 shown in FIG. 3, to determine whether the DRAM has been powered off. Further, in at least certain embodiments, the return from operation 105 to operation 101 also includes restoring state information in a microprocessor from data stored in the volatile memory, such as DRAM memory. If an input has not been received as determined in operation 105, then processing proceeds to operation 107 in which it determines whether or not the timer, started in operation 103, has expired. If not, processing loops back to perform operation 105 again. If the timer has expired then processing proceeds in one embodiment to operation 109. While the embodiment shown in FIG. 1 uses the expiration of a timer to determine whether or not volatile memory should be powered off, it will be appreciated that in other embodiments, another event, such as a user command (e.g. a specific set of keys on a keyboard) could be used (either alternatively to the timer or in addition to the timer) to cause the system to power off the volatile memory. It will be appreciated that a timer or counter may be used to determine whether to power off the volatile memory. A timer may count or time an actual period of time, and a counter may count down from a value to zero or in some other way without regard to time.

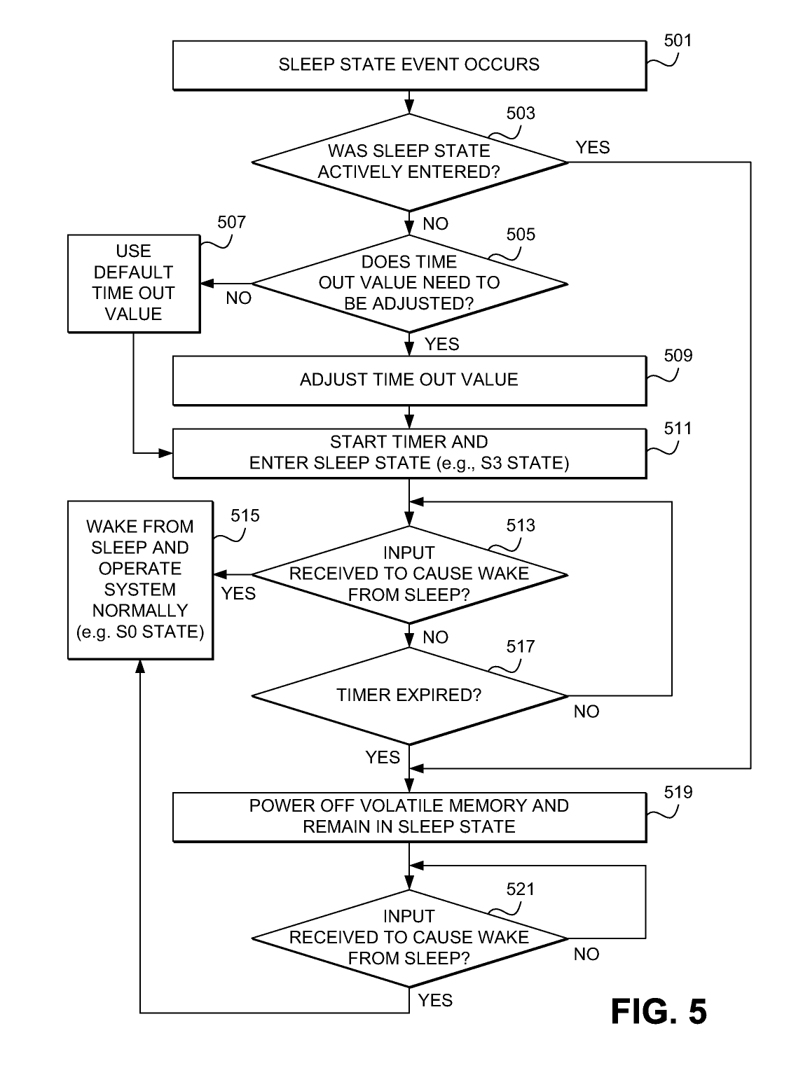

In certain embodiments, power is removed from the volatile memory when both the timer (DRAM timer) expires and another condition is satisfied. This other condition can be determined by, for example, software that detects the state of applications (e.g. opened or quit) or the state of data entry operations (e.g. a save dialog or an open dialog in the front most window), or a combination of such states and operations and determines whether or when it is time to remove power from the volatile memory even if the timer has already expired. Certain embodiments pertaining to this other condition will be discussed below with respect to FIG. 5.

Upon determining that the timer or counter has expired in operation 107 (and assuming no other condition is required to proceed to operation 109), the method proceeds to operation 109 in which power to the volatile memory is either completely turned off or reduced substantially. In one embodiment, this involves removing power completely from the DDR DRAM. However, the system otherwise remains in the same sleep state which was entered into in operation 103, such as an S3 sleep state. In one embodiment, the system will have identical observable behaviors as a system in a normal S3 sleep state after powering off the volatile memory in operation 109. For example, an optional sleep indicator, such as an LED on the data processing system, can indicate the sleep state which it was indicating after entering the sleep state in operation 103 and after operation 109. In addition, one or more wake sources (e.g., peripheral devices such as a mouse, touch pad, keyboard, etc.) remain powered and capable of providing an input to cause a wake from sleep. The wake sources may be connected to the data processing system in a number of ways such as via USB, Ethernet, Bluetooth, or another way. The wake sources are not powered off, as in an S4 or S5 state where the wake sources are powered off and the system typically responds only to a power button press. In certain embodiments, there is a plurality of wake sources capable of providing the input to cause a wake from the sleep state.

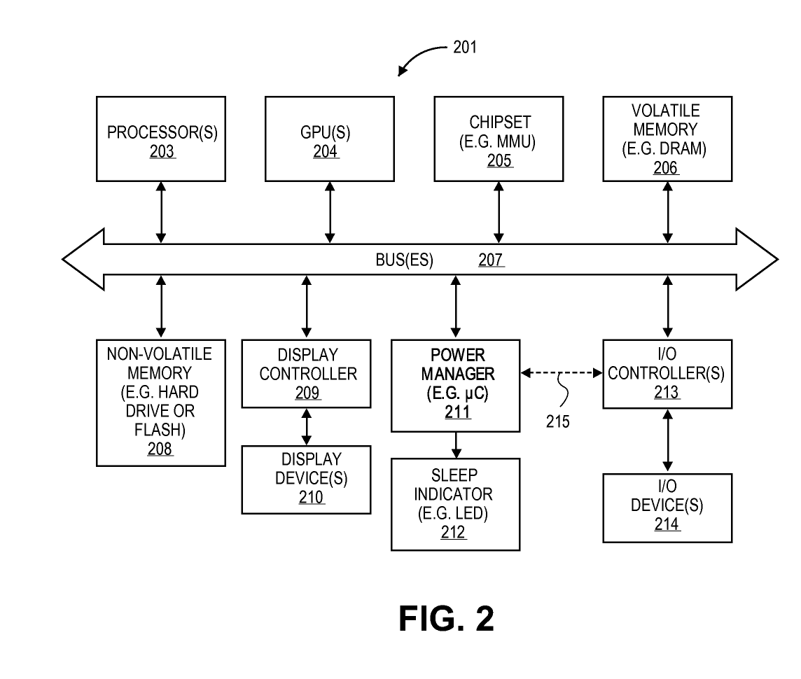

Operation 111 follows operation 109 and determines whether or not an input has been received to cause a wake from sleep. If no input has been received, then processing repeatedly performs operation 111 until an input is received to cause a wake from sleep. This input may be from any one of a plurality of peripherals coupled to the data processing system or from only a subset of those peripherals. If it is determined in operation 111 that an input has been received to cause a wake from sleep, then the system will perform, in at least certain embodiments, several operations in order to allow the system to return to operation 101. In one embodiment, these operations, in returning from operation 111 to operation 103, include reading a value from a register which specifies the state of whether the volatile memory is powered on or off (e.g. reading the value of data in register 313 as described further below) and then if power has been removed from the volatile memory (i.e., it is powered off), reinitializing and resetting the volatile memory, and then restoring, from a non-volatile memory, the state of the volatile memory which existed upon entering the sleep state in operation 103. In one embodiment, the restoration of the DRAM occurs from the image of the DRAM in a hard drive or flash memory, which image was saved in either operation 103 or 109 as described above. Then after restoring the DRAM from the non-volatile memory, the system state, such as processor states, etc. are restored from the DRAM or volatile memory and then processing can proceed to operate normally in operation 101. The foregoing method shown in FIG. 1 will be described further below in conjunction with several embodiments shown, for example, in FIG. 2 and in FIG. 3, etc.

FIG. 2 is an example of a data processing system which may be used with any one of the embodiments described herein. This data processing system can represent a general purpose computer system or a special purpose computer system. It can represent a handheld computer or a personal digital assistant or a mobile telephone, a portable gaming system, a portable media player, or a tablet or handheld computing device which may include a mobile telephone or a mobile media player or a gaming system or a network computer or an embedded processing device within another device or any consumer electronic device. The system may include any one of a plurality of or a combination of data input peripherals including, for example, a keyboard, a mouse, a touch screen, a touch pad, a USB port, or a storage drive such as a DVD or CD drive, etc. The data processing system 201 as shown in FIG. 2 can include one or more processors 203 and one or more graphics processing units (GPUs) 204 coupled to each other through one or more buses 207. The processors may be conventional microprocessors, such as a microprocessor from Intel or a special purpose processor, such as a processor created through an ASIC (Application Specific Integrated Circuit). The graphics processing unit 204 may be a conventional graphics processing unit such as a GPU available from NVIDIA. The system 201 can also include a chipset which includes a memory management unit. The chipset 205 can be a conventional chipset or a chipset modified to include a power manager which implements one or more methods described herein. Processors 203, GPUs 204, and chipset 205 can be implemented within one integrated circuit or in several integrated circuits. The data processing system 201 also includes a volatile memory which may be DRAM which requires refreshing in order to maintain data within the memory. Volatile memory 206 is coupled to the chipset 205 and the GPU 204 and the processor 203 through one or more buses 207. It will be appreciated that the architecture of the system 201 is not intended to represent any particular architecture or manner of interconnecting the components as such details are not germane to the present invention and that the buses 207 may include one or more buses and bus bridges, controllers, and/or adapters as is known in the art. In one embodiment, the processor 203 retrieves computer program instructions stored in a machine readable storage medium such as the volatile memory 206 or the non-volatile memory 208 or a combination of those memories and executes those instructions to perform operations described herein. The power manager 211 and the chipset 205 may also include memory to store instructions that are executed to perform operations described herein. The non-volatile memory 208 may be a hard drive or flash memory or phase change memory (PCM) or other types of memory in which the data and instructions are retained after power is removed from the memory device which forms the non-volatile memory 208. The system 201 also includes a display controller 209 which is used to control one or more display devices 210 as is known in the art. The display controller 209 can be coupled to the rest of the system through the buses 207 or in other embodiments directly to the graphics processing unit 204. The system 201 also includes one or more input/output (I/O) controllers 203 which are coupled to one or more input/output devices 214, such as a touch screen or a touch pad or a mouse, or a keyboard or a USB port or a network interface controller (wired or wireless or both) or a combination of such data input peripherals. Finally, the system 201 includes a power manager 211 which may be a microcontroller or an ASIC configured to perform power management operations in accordance with one or more embodiments of the present invention. The power manager may be coupled through one or more buses 207 to communicate with the chipset 205 and other components in the system. The power manager 211 can also include a sleep indicator which may be one or more LEDs to indicate that the system is in a sleep state as described herein. Sleep indicator 212 is coupled to, in this embodiment, the power manager directly but in other embodiments may be coupled through an input/output controller which in turn is controlled or managed by a power manager in one embodiment or the chipset 205 in another embodiment as described herein. The system 201 can include an optional connection between the I/O controller 213 and the power manager 211 in order to allow the power manager to monitor inputs from the data input peripherals in order to determine whether or not to wake the system from sleep as described in the one or more embodiments of this disclosure. In other embodiments, the input/output controllers 213 can communicate with a power manager, such as power manager 211 through chipset 205 rather than through an optional connection 215. In certain embodiments, input/output devices 214 can include wireless transceivers, such as Bluetooth transceivers, WiFi transceivers, infrared, cellular telephone transceivers, etc. Furthermore, the input/output devices 214 may include network interfaces, such as an Ethernet interface or other network interfaces. It will also be appreciated that data processing systems of the present invention may have fewer components than those shown in FIG. 2 or more components than those shown in FIG. 2. It will also be appreciated that the coupling of the one or more processors, chipset, graphics processing units, is typically through one or more buses and bridges, also known as bus controllers, as is known in the art.

FIG. 3 presents, in block diagram form, a more specific example of an embodiment in which a power manager, such as the power manager 211 can, in conjunction with chipset logic, perform one or more of the power reduction operations described herein and the methods described herein. The system 301 may be part of the system 201 in one embodiment and includes chipset logic 303, power manager 305, DRAM 307, and DRAM voltage regulator 309, coupled as shown in FIG. 3. The chipset logic 303 can include memory management logic or units for managing the volatile memory such as the DRAM 307. Chipset logic 303 can also include other conventional logic, such as glue logic for interconnecting the one or more processors, I/O controllers, and other components in the system as is known in the art. The system 301 can also include a sleep indicator which in this case is the LED 311 which is coupled to the power manager 305 which controls the LED to cause it to indicate a sleep state, such as the S3 sleep state as shown in FIG. 1. The power manager 305 also includes one or more registers 313 which allow the power manager to store values indicating the state of power of the DRAM 307 according to one embodiment. The memory 313 can be used to store the on/off state of the DRAM which can be read by the chipset logic through line 331 when an input is received to cause the system to wake from sleep. This has been described above in connection with the “yes” exits from decision blocks 105 and the decision block 111 described in conjunction with FIG. 1. In one embodiment, a BIOS can cause the chipset to read, through line 331, data indicating the state of the DRAM and the wake state to determine whether or not the DRAM was powered off and hence requires a reinitialization and resetting of the DRAM before attempting to store values or data in the DRAM. In one embodiment, the reinitialization and resetting of the DRAM, which was powered off, can be performed in a shortened period of time relative to a standard reinitialization and resetting. Bus 315 can be a conventional control bus coupling chipset logic 303 with DRAM 307 in order to control the DRAM. Further, bus 315 can include address and data lines depending upon the embodiment of the chipset and the DRAM 307. Chipset 303 can indicate the power state of the system, such as an S0 state, an S3 state or an S5 state through the power signal lines 317. This will inform the power manager 305 of the state of the system and the power manager can act accordingly to set power states in response to the power signal lines 317 from chipset logic 303. Power manager 305 also includes an output which controls the gate control signal 319 which is coupled to the gate of the control transistor (FET) 321 which provides the power to the DRAM 307. In particular, FET 321 can be used to turn on and turn off the power to the DRAM 307. One electrode of FET 321 is coupled to the voltage output from the DRAM voltage regulator 309, which voltage output 323 provides a voltage to the voltage input 325 of the DRAM 307 when the FET 321 is turned on by a signal applied to the gate control signal 319. The power manager 305 controls the voltage on the gate control signal and thereby controls whether or not power is supplied to the DRAM 307. Chipset logic 303 has an output to provide the voltage enable signal 327 which is received on the enable input 329 on the voltage regulator 309. When the chipset logic enables the DRAM voltage regulator through the voltage enable signal 327, then the DRAM voltage regulator 309 can provide the voltage necessary to power the DRAM 307 through the control FET 321. The power manager 303 may include a timer or counter which is started in operation 103 (e.g. DRAM timer) and which is used in operation 107 to determine whether or not the timer or counter has expired. The expiration of this timer or counter is then used, in operation 109, by the power manager 305 to cause the DRAM 307 to be powered off as in operation 109 described above. Power manager 305 and chipset logic 303 can together perform the various operations to implement the method shown in FIG. 1.

The operation of system 301 will now be described in relation to the method shown in FIG. 1. When the data processing system which includes system 301 is operating in a normal state, such as the S0 state in operation 101, the chipset logic 303 and DRAM 307 are fully powered and performing their normal functions, and the power manager 305 stores a value in register 313 indicating that the DRAM has full power. Power manager 305 also causes LED 311 to indicate a normal operating state rather than a sleep state. Power signal lines 317 are set by chipset logic 303 to specify the S0 or other normal operating state to power manager 305 and chipset logic 303 enables the DRAM voltage regulator 309 to provide an operating voltage through the FET 321 to DRAM 307. At some point, the system can enter a sleep state as described above, and chipset logic 303 can instruct power manager 305 to enter the sleep state by changing values on the power signal lines 317. In turn, the power manager 305 can start a timer or counter (e.g. DRAM timer) as in operation 103 in order to determine whether and when to power off DRAM 307. During the sleep state, the power manager and/or chipset logic 303 can monitor inputs from data input peripherals as described herein in order to determine whether or not to wake from sleep in operation 105 described above. In addition to these peripherals, the power manager or chipset logic can monitor enclosure controls such as hinges, button covers, lid switches or accelerometers in order to determine whether to wake the system from the sleep state. During this period of time, the DRAM 307 still has power because gate control signal 319 from power manager 305 continues to allow power to be supplied to DRAM 307 through FET 321. Power manager 305 can include a timer or counter which was started in operation 103 for the purpose of determining when to power off the volatile memory which in this case is DRAM 307. When the timer or counter expires as determined in operation 107 (assuming no other condition needs to be satisfied, such as a software determined condition) then power manager 305 can allow the system to remain in the same sleep state except that the volatile memory is powered off by changing the gate control signal 319 to turn off FET 321 which, in turn, turns off power to DRAM 307. Chipset logic 303 can still provide voltage enable signal 327 to the enable input 329 of the DRAM voltage regulator 309 while in this sleep state or, in an alternative embodiment, DRAM voltage regulator 309 may also be powered off either directly by chipset logic 303 or by a signal from power manager 305 to cause DRAM voltage regulator 309 to be powered off when the DRAM 307 is powered off in the sleep state, such as the S3 state. Power manager 305, when it powers off DRAM 307, can also cause sleep indicator 311, which is an LED in this case, to indicate that the system is in a sleep state. In one embodiment, LED 311 shows the sleep state starting in operation 103 and remains in that condition through operations 105, 107 and 109 and 111 of FIG. 1. Power manager 305, upon powering off DRAM 307, also stores a value in register 313 indicating that the power is off for DRAM 307, and this register is used, upon receiving an input to cause the system to wake from sleep, in order to reinitialize and reset the powered off DRAM 307 as described herein. Power manager 305 or chipset logic 303 or a combination of power manager 305 and a portion of chipset logic 303 can monitor one or more inputs received from one or more data input peripherals (and optionally monitor other components such as one or more enclosure electromechanical controls such as hinges, button covers, lid switches or accelerometers and such as internal microcontrollers (e.g. camera with presence detection, etc.)) during operation 111 in order to determine whether or not to cause the system to wake from sleep. If such input is received, then power manager 305 causes LED 311 to stop indicating the sleep state and causes DRAM 307 to be reinitialized and reset by, among other things, providing gate control signal to turn on FET 321 to thereby supply power to DRAM 307. If voltage enable 327 was previously disabled, then it will be enabled to allow DRAM voltage regulator 309 to provide the power needed for DRAM 307 to operate normally. Chipset logic 303 can read data from register 313 to determine whether or not DRAM 307 was powered off during the sleep state. If it was not powered off then no reinitialization and no resetting of DRAM 307 is necessary. Then the system restores data in the DRAM 307 from the non-volatile memory which contains an image of the data in DRAM 307 prior to sleeping and then the system restores the system state from the DRAM 307.

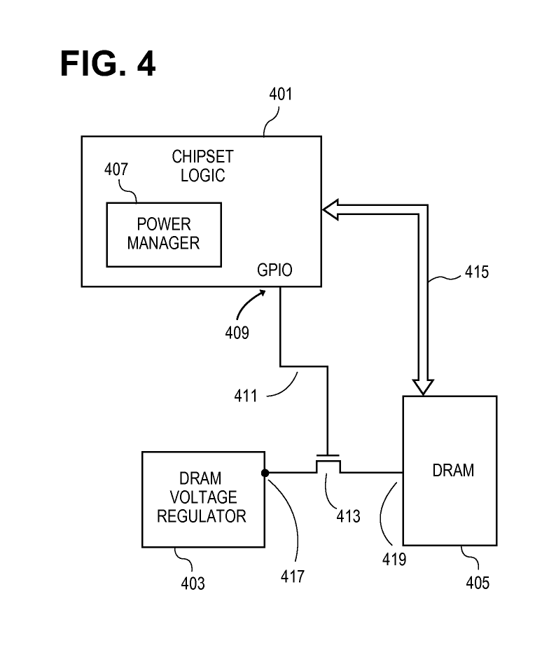

FIG. 4 shows an alternative embodiment of a chipset and power management logic which is integrated together; in other words, the power manager 407 is embedded within chipset logic 401 which may be the same as chipset logic 205 shown in FIG. 2. In this case, there is no need for a separate power manager 211. Chipset logic 401 can include, in addition to power manager 407, a memory management unit and other logic such as glue logic for coupling together the various components of the system and for controlling the one or more buses of the system. Chipset logic 401 can be coupled to DRAM 405 through a control bus 415. DRAM 405 corresponds to volatile memory 206 of FIG. 2 and receives power from a DRAM voltage regulator 403 through an FET 413 which is controlled by gate control line 411 which receives a signal from the GPIO 409, which is a general purpose input/output connection on chipset logic 401 in one embodiment. Voltage output 417 of the DRAM voltage regulator 403 provides the necessary operating voltage for DRAM 105 through the FET 413 and into the voltage input 419 of DRAM 405 when the gate control line 411 turns on the FET 413. In sleep state, such as sleep state S3 in operation 103, GPIO logic which drives GPIO 409 will be in a power domain that remains powered in the S3 state, and similarly power manager 407 will also remain powered during the S3 state. Control of GPIO 409 may be performed by power manager 407 or it may be controlled through instructions executed by the system processor such as processor 203 of FIG. 2. If the GPIO 409 is controlled by a processor then the system must briefly return to the S0 state such that the processor and chipset are powered sufficiently to allow the processor to execute instructions required to toggle the GPIO in order to allow power to be provided to the DRAM when exiting the sleep state or to remove power when entering the sleep state. Note that in this scenario, the system may lose access to DRAM for a brief period of time while in the S0 state and hence logic or software should ensure that there are no attempts to access the DRAM after the GPIO 409 has been toggled to power down memory.

In certain embodiments, a data processing system, such as the system shown in FIG. 2, can enter a low power or sleep state and remove or reduce power to a volatile memory, while remaining in the sleep state. Power may be intelligently removed from the volatile memory depending on the conditions during which the processing system enters the sleep state. FIG. 5 shows a method for entering a sleep state and intelligently removing power from the volatile memory according to one embodiment of the present invention. In operation 501, a sleep state event occurs. The sleep state event can cause the system to enter a sleep state, which may be for example, an S3 state. The system may enter the sleep state in a number of ways including the expiration of a sleep timer or through receiving a user command (e.g., a button press) which instructs the system to enter the sleep state. In operation 503, the sleep state event is analyzed by the system to determine if the sleep state was actively entered. If certain conditions are met, the system determines that a user intended for the system to enter the sleep state. These conditions may include a button press, a specific key sequence, the closing of a lid, the removal of a power cord, or other forms of user input or interaction with the system. If the system determines that the sleep state event indicates that the sleep state was actively entered, in one embodiment, at operation 519 the system enters the sleep state and powers off the volatile memory. The power to the volatile memory may be either completely turned off or reduced as described above. The volatile memory may be powered off at the same time that the system enters the sleep state or a short period of time thereafter.

If at operation 503, the system determines that the sleep state was not actively entered (e.g., a sleep timer or counter expired as discussed above with respect to FIG. 1), at operation 505, the system determines if the sleep state event should adjust a time out value of a DRAM timer or counter. A number of conditions may be defined that adjust the time out value from a default value. Certain conditions may cause the time out value to be increased, causing more time to pass before the volatile memory (e.g., DRAM) is powered off, while other conditions may cause the time out value to be decreased. These conditions may include, for example, the state of an accelerometer or motion sensor in the system, the battery charge level, the state of a proximity sensor, the state of an application running on the system, the state of data entry operations, or any combination of these states and/or other states, operations or conditions. In one embodiment, if an accelerometer or motion sensor detects movement of the data processing system, it may be determined that the user does not intend to use the system anytime soon, and at operation 509 the time out value is decreased, causing the volatile memory to be powered off sooner in the absence of an input to cause wake from sleep. Other conditions that may cause the time out value to be decreased include the battery charge level dropping below a certain threshold value, all applications running on the system being closed or exited or a proximity sensor detecting that no user is near the processing system. Conditions that may cause the time out value to be increased at operation 509, allowing a longer period of time before the volatile memory is powered off, include one or more applications currently being open or run when the sleep state event occurs, a dialog box (e.g., a save dialog or an open dialog) being open in the front most window, the detection by a proximity sensor that the user is within a certain distance of the system, or other conditions. If no condition exists that would adjust the time out value, a default time out value may be programmed into the timer or counter at operation 507.

In operation 511, the system starts the timer or counter using the value determined at either operation 507 or 509 and causes the system to enter a sleep state (e.g., S3 state). In the sleep state, the processor, such as processor 203, of the data processing system is powered off. However, one or more wake sources remain powered during the sleep state. The wake sources may include, for example, peripheral devices, such as a mouse or keyboard, connected via USB, an Ethernet connection, or Bluetooth devices. These wake sources are monitored for input at operation 513 which can cause the system to wake from the sleep state and return to a normal operating state (e.g., S0 state) at operation 515. If the DRAM timer has expired at operation 517 before an input signal has been received from a wake source (and if no other condition, such as a software state, is required to power off the volatile memory), the volatile memory is powered off and the system otherwise remains in the sleep state. The other conditions which can further delay or prevent turning off power to the volatile memory can include a save or open dialog being the front most window or other conditions described herein. While power to the volatile memory may be either removed or reduced, the various wake sources in or attached to the data processing system remain powered. Thus, if input is received from a wake source at operation 521, even after the volatile memory has been powered off at operation 519, the system can return to a normal operating state. The wake sources may be continually monitored while the system is in the sleep state and the volatile memory has been turned off until input is received to cause the system to wake from the sleep state.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A data processing system comprising:
a volatile memory;
at least one data input peripheral;
a logic circuit configured to manage power consumption of the data processing system to maintain a sleep state of the data processing system, the logic circuit coupled to the volatile memory and to the at least one data input peripheral, the logic circuit being configured to, in response to an input from the data input peripheral, cause the system to exit from the sleep state, and the logic circuit being configured to turn off power to the volatile memory in response to an event occurring during the sleep state and to cause the data processing system to otherwise remain in the sleep state.

2. The data processing system as in claim 1, wherein the event causes the power to be removed from the volatile memory immediately upon the data processing system entering the sleep state, the event comprising one of a button press, a key sequence input, closing of a lid of the processing device, and removal of a power cord.

3. The data processing system as in claim 1, wherein the event is an expiration of a timer that is begun in response to the entering of the sleep state.

4. The data processing system as in claim 3, wherein a time out value of the timer is adjusted based on a condition of the data processing system when the sleep state is entered, the condition comprising one of a state of an accelerometer or motion sensor, a battery charge level, a state of a proximity sensor, a state of an application running on the data processing system, and a state of a data entry operation in the application.

5. The data processing system as in claim 1, wherein the volatile memory is a dynamic random access memory (DRAM) that requires refreshing to maintain data in the DRAM and wherein the at least one data input peripheral is one of (a) a mouse; (b) a touchpad; (c) a touch screen; (d) a keyboard; (e) a USB port; (f) a storage drive; (g) a network interface controller, wherein the at least one data input peripheral remains powered after power to the volatile memory is turned off, and wherein the at least one data input peripheral is coupled to an input controller to provide data to at least one processor which is coupled to the volatile memory and wherein the data processing system comprises a bus that couples the at least one processor to the volatile memory and wherein the logic circuit is configured to cause the system to exit from the sleep state in response to a signal from an enclosure electromechanical control.

6. The data processing system as in claim 5, wherein the sleep state is an S3 ACPI (Advanced Configuration and Power Interface) compliant state prior to the event and wherein the data processing system further comprises:
a sleep indicator coupled to the logic circuit, the sleep indicator indicating that the data processing system is in the sleep state when the data processing system is in the S3 ACPI compliant state; and
wherein the logic circuit is configured to return power to the volatile memory in response to an exit from the sleep state.

7. The data processing system as in claim 6, further comprising:
a non-volatile memory coupled to the at least one processor, the at least one processor being configured to cause the storage of the data in the DRAM into the non-volatile memory before entering the sleep state and wherein the at least one processor and the non-volatile memory are in a power off state during the sleep state.

8. The data processing system as in claim 7, wherein the data processing system is capable of operating in at least the following ACPI compliant states: S0, S3; and S5, and wherein the expiration of the timer or counter occurs after a period of time in which no inputs are received from the at least one data input peripheral and wherein the timer is begun in response to entering of the sleep state, and wherein the at least one data input peripheral provides user data used by the data processing system after it has achieved an S0 state.

9. A machine implemented method of a data processing system, the method comprising:
determining that the data processing system has entered a sleep state in which a volatile memory of the data processing system receives power and a processor of the data processing system is powered off, wherein the data processing system being configured to exit from the sleep state in response to an input from a data input peripheral;
determining that an event has occurred while the data processing system is in the sleep state; and
removing power from the volatile memory in response to the event and causing the data processing system to remain in the sleep state.

10. The method as in claim 9, wherein the event causes the power to be removed from the volatile memory immediately upon the data processing system entering the sleep state, the event comprising one of a button press, a key sequence input, closing of a lid of the processing device, and removal of a power cord.

11. The method as in claim 9, wherein the event is an expiration of a timer that is begun in response to the entering of the sleep state.

12. The method as in claim 11, wherein a time out value of the timer is adjusted based on a condition of the data processing system when the sleep state is entered, the condition comprising one of a state of an accelerometer or motion sensor, a battery charge level, a state of a proximity sensor, a state of an application running on the data processing system, and a state of a data entry operation in the application.

13. The method as in claim 9, further comprising:
causing a sleep indicator to indicate a sleep condition when the data processing system is in the sleep state; and
wherein the data input peripheral is one of (a) a mouse; (b) a touchpad; (c) a touch screen;
(d) a keyboard; (e) a USB port or (f) a storage drivel, wherein the data input peripheral remains powered after power is removed from the volatile memory; and
wherein the volatile memory is a random access memory (RAM) that requires refreshing to maintain data in the RAM.

14. The method as in claim 13, wherein the sleep state is an S3 ACPI compliant state prior to the event and wherein the sleep indicator indicates the sleep state after the event.

15. The method as in claim 14, further comprising:
storing data in the RAM into a non-volatile memory before entering the sleep state; and
wherein the data processing system comprises at least one processor and wherein the at least one processor and the non-volatile memory are in a powered off state during the sleep state.

16. The method as in claim 15, wherein the data processing system is capable of operating in at least the following ACPI compliant states: S0; S3; and S5; and wherein the expiration of the timer occurs after a period of user inactivity relative to the data input peripheral.

17. The method as in claim 16, wherein the data processing system comprises a plurality of data input peripherals and wherein the expiration of the timer occurs after a period of user inactivity relative to all of the plurality of data input peripherals.

18. A machine readable storage medium storing instructions which when executed cause a data processing system to:
determine that the data processing system has entered a sleep state in which a volatile memory of the data processing system receives power and a processor of the data processing system is powered off, wherein the data processing system being configured to exit from the sleep state in response to an input from a data input peripheral;
determine that an event has occurred while the data processing system is in the sleep state; and
remove power from the volatile memory in response to the event and causing the data processing system to remain in the sleep state.

19. The machine readable storage medium as in claim 18, wherein the event causes the power to be removed from the volatile memory immediately upon the data processing system entering the sleep state, the event comprising one of a button press, a key sequence input, closing of a lid of the processing device, and removal of a power cord.

20. The machine readable medium as in claim 18, wherein the event is an expiration of a timer that is begun in response to the entering of the sleep state.

21. The machine readable medium as in claim 20, wherein a time out value of the timer is adjusted based on a condition of the data processing system when the sleep state is entered, the condition comprising one of a state of an accelerometer or motion sensor, a battery charge level, a state of a proximity sensor, a state of an application running on the data processing system, and a state of a data entry operation in the application.

22. The machine readable medium as in claim 18, wherein the instructions further cause the data processing system to:
cause a sleep indicator to indicate a sleep condition when the data processing system is in the sleep state; and
wherein the data input peripheral is one of (a) a mouse; (b) a touchpad; (c) a touch screen;
(d) a keyboard; (e) a USB port or (f) a storage drivel, wherein the data input peripheral remains powered after power is removed from the volatile memory; and
wherein the volatile memory is a random access memory (RAM) that requires refreshing to maintain data in the RAM.

23. The machine readable medium as in claim 22, wherein the expiration of the timer occurs after a period of user inactivity relative to the data input peripheral.
